(19) United States
(12) Patent Application Publication
(10) Pub. No.: US 2017/0360004 A1
(43) Pub. Date: Dec. 21, 2017

(54) DOG TRAIN & TRACK SYSTEMS

(71) Applicant: Joan E. Carver, Kelowna (CA)

(72) Inventor: Joan E. Carver, Kelowna (CA)

(21) Appl. No.: 15/186,373

(22) Filed: Jun. 17, 2016

(51) Int. Cl. A01K 15/02; A01K 27/00; A01K 29/00

(52) U.S. Cl. CPC A01K 15/023; A01K 29/005; A01K 27/001; A01K 27/006; A01K 27/009

(57) ABSTRACT

A dog train & track system for tracking a pet using a GPS. The system is housed inside a collar made of waterproof material to house all of the components necessary to use and power the system. The software accompanying the collar permits the owner to set boundaries and send a notification to the owner through the software on a computer or smart device in the event the pet leaves the boundary. Furthermore, the system notifies the owner and others in cases were the pet may become distressed. The system may also communicate with a pet door allowing entry into the owner's home using proximity detection within the collar.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pet collars and more specifically relates to the dog train & track system.

### 2. Description of Related Art

Many people like to know that their pet is safe and wish to be notified immediately in case their pet becomes distressed. Generally, a pet is kept secure on a lead or in a fenced in portion of their property. Unfortunately, a pet may still be capable of escaping a fence, or slipping a lead when an owner is otherwise occupied. When a pet escapes, the owner may not know that the pet is missing until some time has passed. The longer a pet is missing the more laborious it becomes to locate the pet.

In cases where a pet must be left unattended for an extended period of time, it can be difficult to ascertain if the pet is still safe and in the area where the pet was left. When walking a pet, or taking the pet to the park, the pet may run off without the owner's knowledge, resulting in a search to locate the pet. Traditional collars may have the owner's information imprinted on them, which may help in the event the pet is found by a responsible party; however, they do not offer a way to immediately notify an owner in events of escape/distress for their pet. A suitable solution is therefore desired.

Several attempts have been made to solve the above-mentioned problems such as those found in U.S. Pub. No. 2013/0271281 to Gordon Jessop; U.S. Pub. No. 2007/0221140 to Jonathan Warren et al.; U.S. Pub. No. 2002/0021219 to Marlena Edwards; U.S. Pub. No. 2007/0222624 to Gail Eicken et al.; U.S. Pub. No. 2009/0289785 to Ellen Leonard; U.S. Pat No. 6,283,065 to John Ernest Turner Shorrock et al; U.S. Pat No. 8,514,070 to Clark L. Roper et al.; U. S. Pat No. 6,970,090 to Michael Sciarra; U. S. Pat No. 6,067,018 to Joan M. Skelton et al.; U. S. Pat No. 6,441,778 to Jennifer Durst et al.; U. S. Pat No. 9,055,733 to Jones II Johnny; International Pat No. WO/2008104810 to Jon Bryan; International Pat No. WO2013050763 to Andrew Stuart et al.; International Pat No. WO2011032055 to Jason A. Hardi et al.; International Pat No. WO/200503461 to Bjoern Thorstensen et al; International Pat No. AU2012101881 to Byron Clifford Hill et al.; International Pat No. CN202317987 to Yan its first; International Pat No. CN104472393 to Li Zhao; and International Pat No. CN101930066 to MM Zhuoen. This art is representative of pet collars. However, none of the above inventions and patents, taken either singly or in combination, is seen to describe the invention as claimed.

Preferably, a dog train & track system should provide tracking of a pet and monitoring should the ambient temperature in the pet's environment change beyond tolerable levels in cases of emergency and, yet would operate reliably and be manufactured at a modest expense. Thus, a need exists for a reliable dog train & track system to avoid the above-mentioned problems.

### BRIEF SUMMARY OF THE INVENTION

In view of the foregoing disadvantages inherent in the known pet collar art, the present invention provides a novel dog train & track system. The general purpose of the present invention, which will be described subsequently in greater detail is to provide a pet tracking system which provides tracking of the pet and monitors pet vital signs in cases of emergency.

A dog train & track system is disclosed herein, in a preferred embodiment, comprising: a dog train & track assembly comprising a collar comprising, an inner volume comprising, a central processing unit comprising, a GPS, an antenna, a wiring harness, a microphone, a speaker, a transmitter, a battery, a fastener comprising a pressure detecting lock comprising, an alarm wire and a charging port. The dog train & track system comprises the dog train & track assembly. The dog train & track assembly comprises in functional combination the collar, the fastener, and the charging port in a unitary design. The collar comprises the inner volume, allowing for incorporation of the central processing unit and the battery. The dog train & track assembly comprises waterproof material and is sealed to prevent damage to components contained within the inner volume. The collar comprises a micro-digital camera for viewing the immediate surroundings while tracking the pet. The collar comprises a light emitting diode for easy locating of the pet in low light/dark conditions. The micro-digital camera allows the user to record media to review for training purposes.

The inner volume may further comprise a thermometer for remotely detecting the pet's temperature and alerting the owner in cases of distress. The central processing unit comprises in functional combination, the GPS, the antenna, the wiring harness, the microphone, the speaker, and the transmitter for training and tracking purposes. The speaker emits an audible command to the pet instructing the pet to return to a home location. The antenna receives instructional data from the owner, wherein the instructional data, when input by the owner, is trackable by way of software for the dog train & track system. The transmitter conveys information comprising the instructional data to the owner operating the software. The central processing unit comprises a proximity sensor, wherein the proximity sensor comprises a digital coded key for disengaging a matching digital lock of a pet-door. Further, the proximity sensor alerts the owner in the event of the pet leaving preset boundaries.

The microphone and the speaker are used in conjunction to provide remote training while a pet is out of the vocal range of an owner. The execution parameters of the audible commands are set by the software as input by the owner, wherein the audible commands are recorded in the voice of the owner to facilitate cooperation of the pet. The central processing unit comprises a low voltage notification for the rechargeable battery. The fastener comprises pressure detecting lock. The pressure detecting lock comprises an alarm wire for communicating alerting when the fastener is disengaged. The transmitter continuously broadcasts a status of the pressure detecting lock.

The charging port is useful for receiving a charging cable to charge a rechargeable battery. The notifications are transmitted to a home computer/mobile device and the notifications are transmitted to multiple users in the event the pet distress notification is not addressed by the owner immediately. The collar and the fastener, when fastened to the pet, permits the owner to track the pet utilizing the central processing unit contained within the inner volume of the collar as well as enabling the owner to train the pet by audible commands using the speaker.

A kit is also disclosed herein including: a collar for attaching to a neck of a pet, a software disc for installing in a computer, a rechargeable battery for powering the collar components, a charge cable for charging the rechargeable battery, and a set of user instructions.

A method of using a dog train & track system is also disclosed herein comprising the steps of: attaching the collar around a neck of the pet; programming the software on the computer; monitoring the pet utilizing the collar; tracking the pet via the collar with GPS function; removing the collar from the pet; and charging the collar with the charge cable. The method may further comprise the step of training the pet.

The present invention holds significant improvements and serves as a dog train & track system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, dog train & track systems, constructed and operative according to the teachings of the present invention.

FIG. 1 shows a perspective view illustrating a dog train & track system during an ‘in-use’ condition showing a pet crossing a preset boundary and a collar sending a notification to an owner using a GPS satellite according to an embodiment of the present invention.

FIG. 2 is a perspective view illustrating the dog train & track system comprising internal components for the GPS, an antenna, a proximity sensor, a rechargeable battery, a thermometer, a micro-digital camera, a speaker, a charge port, and a microphone according to an embodiment of the present invention of FIG. 1.

FIG. 3A is a perspective view illustrating the dog train & track system showing an owner viewing notifications and data sent from the GPS using the provided software disc and the pet accessing a pet door with a proximity sensor according to an embodiment of the present invention of FIGS. 1-2.

FIG. 3B is a perspective view illustrating the dog train & track system showing a pet door with a proximity sensor according to an embodiment of the present invention of FIGS. 1-2.

FIG. 4 is a perspective view illustrating the dog train & track system kit including the software disk, the collar, the charging cable, and a set of user instructions according to an embodiment of the present invention of FIGS. 1-3B.

FIG. 5 is a flowchart illustrating a method of use for the dog train & track system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to pet collars and more particularly to a dog train & track system as used to improve the tracking of a pet in the event the pet leaves a set boundary and also notify the owner if the ambient temperature in the pet's environment changes beyond tolerable levels.

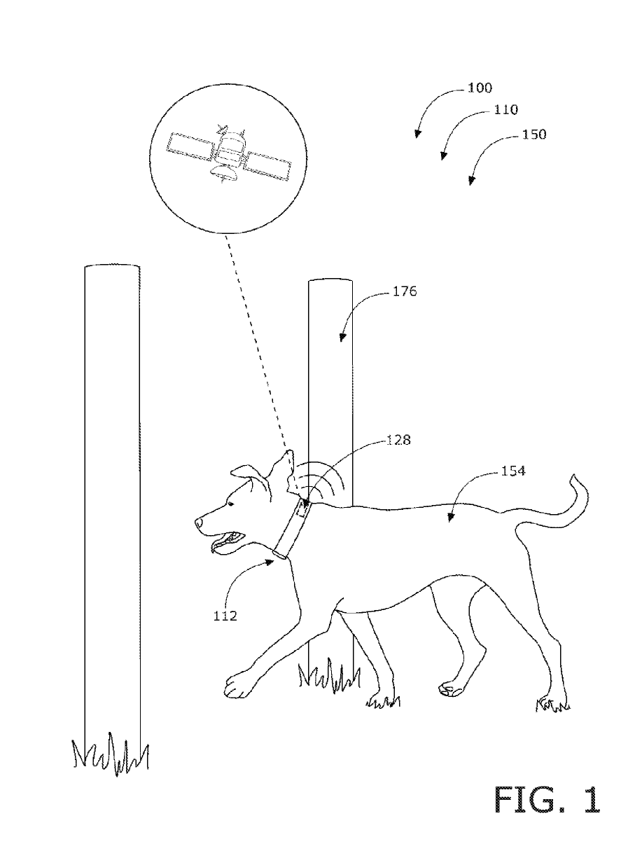

Referring to the drawings by numerals of reference there is shown in FIG. 1, dog train & track system 100 comprising: dog train & track assembly 110 comprising collar 112 comprising inner volume 114 comprising central processing unit 116 comprising GPS 118, antenna 120, wiring harness 122, microphone 124, speaker 126, transmitter 128, rechargeable battery 162, fastener 132 comprising pressure detecting lock 142 comprising alarm wire 144, and charging port 146. Dog train & track system 100 comprises dog train & track assembly 110.

Dog train & track assembly 110 comprises in functional combination collar 112, fastener 132, and charging port 146 in a unitary design. Collar 112 comprises inner volume 114 allowing for incorporation of central processing unit 116 and rechargeable battery 162. Central processing unit 116 comprises in functional combination GPS 118, antenna 120, wiring harness 122, microphone 124, speaker 126, and transmitter 128 for training and tracking 166 purposes. Microphone 124 and speaker 126 are used in conjunction to provide remote training while pet 154 is out of vocal range of owner 140. Central processing unit 116 comprises low voltage notification for rechargeable battery 162.

Fastener 132 comprises pressure detecting lock 142 or other suitably equivalent means for locking. Pressure detecting lock 142 comprises alarm wire 144 for communicating an alert when fastener 132 is disengaged. Charging port 146 is useful for receiving charging cable 164 to charge a rechargeable battery 162. Notifications are transmitted to home computer 158/mobile device. The notifications are transmitted to multiple users 140 in the event the pet distress notification is not addressed by owner 140 immediately. Collar 112 and fastener 132, when fastened to pet 154, permits owner 140 to track pet 154 utilizing central processing unit 116 contained within inner volume 114 of collar 112 as well as enabling owner 140 to train pet 154 by audible commands using speaker 126. Central processing unit 116 comprises proximity sensor 170. Proximity sensor 170 comprises a digital coded key for disengaging a matching digital lock of pet-door 172.

Collar 112 comprises micro-digital camera 174 for viewing immediate surroundings while tracking pet 154. Micro-digital camera 174 allows user 140 to record media to review for training purposes. Antenna 120 receives instructional data from owner 140. The instructional data, when input by owner 140, is trackable by way of software disc 156 for dog train & track system 100. Transmitter 128 conveys information comprising the instructional data to owner 140 operating software disc 156. Transmitter 128 continuously broadcasts a status of pressure detecting lock 142.

Proximity sensor 170 alerts owner 140 in the event of pet 154 leaving preset boundaries 176. Speaker 126 emits an audible command to pet 154 instructing pet 154 to return to a home location. Execution parameters of the audible command are set by software disc 156 as input by owner 140. The audible commands are recorded in voice of owner 140 to facilitate cooperation of pet 154. Inner volume 114 further comprises thermometer 178 for remotely detecting pet 154 temperature and alerting owner 140 in case of distress. Dog train & track assembly 110 comprises waterproof material 180 and is sealed to prevent damage to components within inner volume 114. Collar 112 comprises light emitting diode 182 for easy locating of pet 154 in low light/dark conditions.

Dog train & track system 100 may be sold as kit 440 comprising the following parts: at least one collar 112 for attaching to neck 152 of pet 154, at least one software disc 156 for installing in computer 158, at least one rechargeable battery 162 for powering the collar components, at least one charge cable 164 for charging the rechargeable battery; and at least one set of user instructions 160.

The kit has instructions such that functional relationships are detailed in relation to the structure of the invention (such that the invention can be used, maintained, or the like in a preferred manner). Dog train & track system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different charging/alarming combinations, parts may be sold separately, etc., may be sufficient.

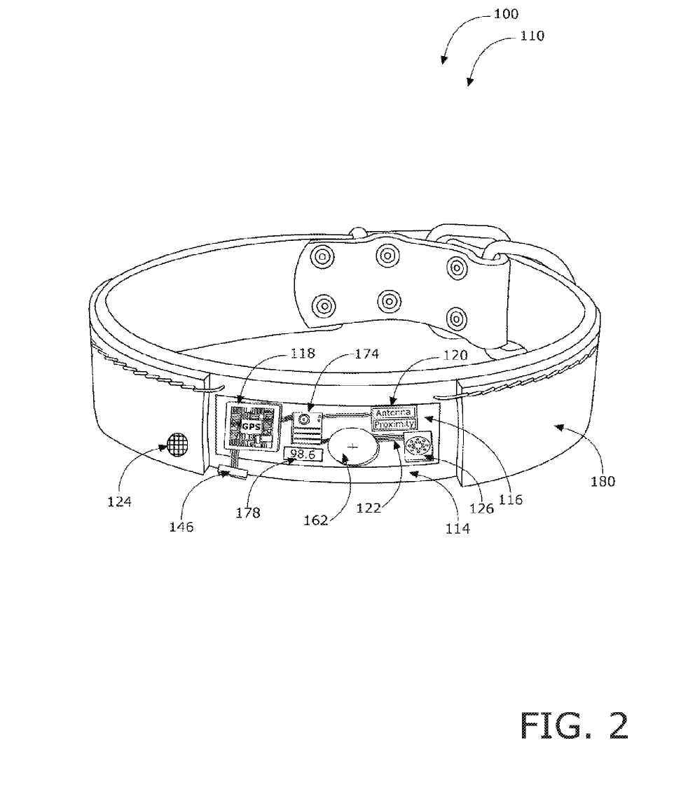

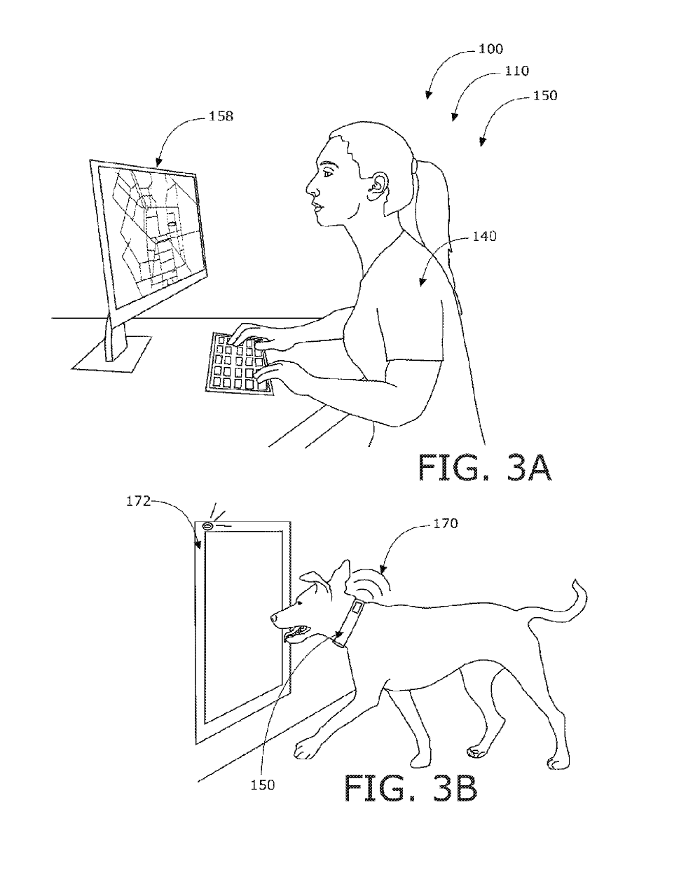

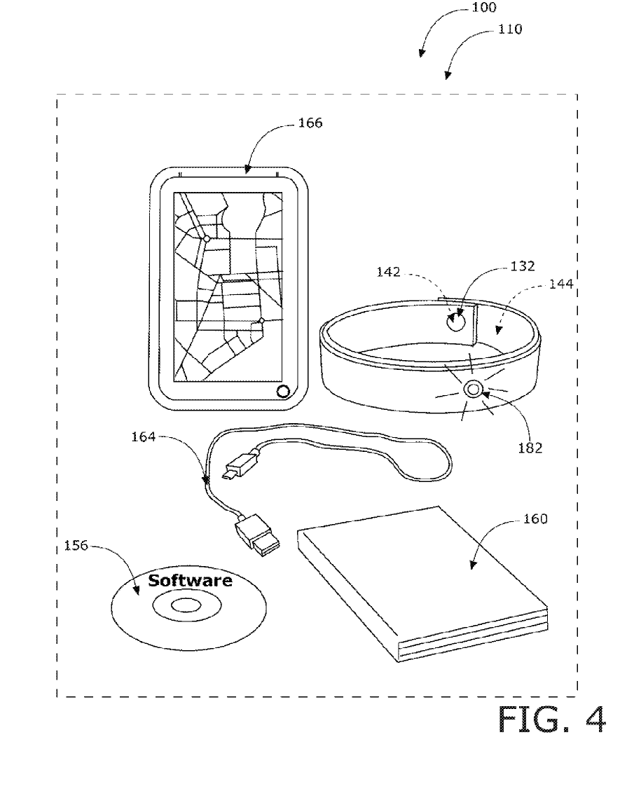

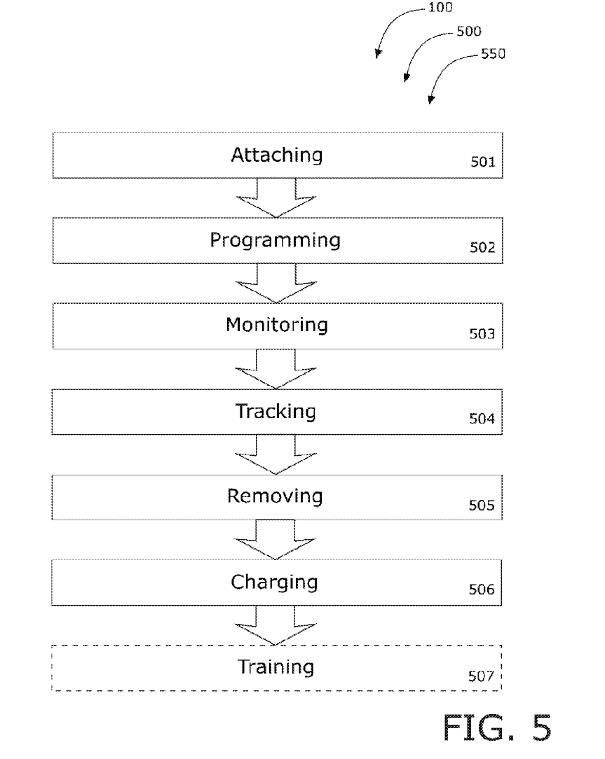

Referring now to FIG. 5 showing flowchart 550 illustrating method of use 500 for dog train & track system 100 according to an embodiment of the present invention of FIGS. 1-4. As shown, method of use 500 may comprise the steps of: step one 501, attaching a collar around a neck of a pet; step two 502, programming software on a computer/mobile device; step three 503, monitoring the pet utilizing the collar; step four 504, tracking the pet via the collar with a GPS function; step five 505, removing the collar from the pet; step six 506, charging the collar with a charge cable; step seven 507, training the pet.

It should be noted that step 507 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of' should not be interpreted as “step for”, in the claims herein and is not intended to invoke the provisions of 35 U.S.C. §112, 91 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A dog train & track system comprising:
a dog train & track assembly comprising;
a collar comprising;
an inner volume comprising;
central processing unit comprising;
a GPS;
an antenna;
a wiring harness;
a microphone;
a speaker; and
a transmitter;
a battery;
a fastener comprising;
a pressure detecting lock comprising;
an alarm wire; and
a charging port;
wherein said dog train & track system comprises said dog train & track assembly;
wherein said dog train & track assembly comprises in functional combination said collar, said fastener, and said charging port in a unitary design;
wherein said collar comprises said inner volume allowing for incorporation of said central processing unit and said battery;
wherein said central processing unit comprises in functional combination said GPS, said antenna, said wiring harness, said microphone, said speaker, and said transmitter for training and tracking purposes;
wherein said microphone and said speaker are used in conjunction to provide remote training while a pet is out of vocal range of an owner.
wherein said central processing unit comprises low voltage notification for said battery;
wherein said fastener comprises said pressure detecting lock and an alarm wire;
wherein said pressure detecting lock comprises said alarm wire for communicating and subsequent alerting when said fastener is disengaged;
wherein said charging port is useful for receiving a charging cable to charge rechargeable said battery;
wherein said notifications are transmitted to a home computer/mobile device;
wherein said notifications are transmitted to multiple users in the event said pet distress notification is not addressed by said owner immediately; and
wherein said collar and said fastener, when fastened to said pet, permits said owner to track said pet utilizing said central processing unit contained within said inner volume of said collar as well as enabling said owner to train said pet by audible commands using said speaker.

2. The dog train & track system of claim 1 wherein said central processing unit comprises a proximity sensor.

3. The dog train & track system of claim 2 wherein said proximity sensor comprises a digital coded key for disengaging a matching digital lock of a pet-door.

4. The dog train & track system of claim 1 wherein said collar comprises a micro-digital camera for viewing immediate surroundings while tracking said pet.

5. The dog train & track system of claim 4 wherein said micro-digital camera allows said user to record media to review for training purposes.

6. The dog train & track system of claim 1 wherein said antenna receives instructional data from said owner.

7. The dog train & track system of claim 6 wherein said instructional data, when input by said owner is trackable by way of software for said dog train & track system.

8. The dog train & track system of claim 7 wherein said transmitter conveys information comprising said instructional data to said owner operating said software.

9. The dog train & track system of claim 8 wherein said transmitter continuously broadcasts a status of said pressure detecting lock.

10. The dog train & track system of claim 2 wherein said proximity sensor alerts said owner in the event of said pet leaving preset boundaries.

11. The dog train & track system of claim 1 wherein said speaker emits an audible command to said pet instructing said pet to return to a home location.

12. The dog train & track system of claim 11 wherein execution parameters of said audible command are set by said software as input by said owner.

13. The dog train & track system of claim 12 wherein said audible commands are recorded in voice of said owner to facilitate cooperation of said pet.

14. The dog train & track system of claim 1 wherein said inner volume further comprises a thermometer for remotely detecting ambient temperature around said pet and alerting said owner in case of distress.

15. The dog train & track system of claim 1 wherein said dog train & track assembly comprises waterproof material and is sealed to prevent damage to components within said inner volume.

16. The dog train & track system of claim 1 wherein said collar comprises a light emitting diode for easy locating of said pet in low light/dark conditions.

17. A dog train & track system comprising:
a dog train & track assembly comprising;
a collar comprising;
an inner volume comprising;
a central processing unit comprising;
a GPS;
an antenna;
a wiring harness;
a microphone;
a speaker; and
a transmitter;
a battery;
a fastener comprising;
a pressure detecting lock comprising;
an alarm wire; and
a charging port;
wherein said dog train & track system comprises said dog train & track assembly;
wherein said dog train & track assembly comprises in functional combination said collar, said fastener, and said charging port in a unitary design;
wherein said collar comprises said inner volume allowing for incorporation of said central processing unit and said battery;
wherein said dog train & track assembly comprises waterproof material and is sealed to prevent damage to components within said inner volume;
wherein said collar comprises a micro-digital camera for viewing immediate surroundings while tracking said pet;
wherein said collar comprises a light emitting diode for easy locating of said pet in low light/dark conditions;
wherein said micro-digital camera allows said user to record media to review for training purposes;
wherein said inner volume further comprises a thermometer for remotely detecting said pet temperature and alerting said owner in case of distress;
wherein said central processing unit comprises in functional combination said GPS, said antenna, said wiring harness, said microphone, said speaker, and said transmitter for training and tracking purposes;
wherein said speaker emits an audible command to said pet instructing said pet to return to a home location;
wherein said antenna receives instructional data from said owner;
wherein said instructional data, when input by said owner is trackable by way of software for said dog train & track system;
wherein said transmitter conveys information comprising said instructional data to said owner operating said software;
wherein said central processing unit comprises a proximity sensor;
wherein said proximity sensor comprises a digital coded key for disengaging a matching digital lock of a pet-door;
wherein said proximity sensor alerts said owner in the event of said pet leaving preset boundaries;
wherein said microphone and said speaker are used in conjunction to provide remote training while a pet is out of vocal range of an owner;
wherein said execution parameters of said audible command are set by said software as input by said owner;
wherein said audible commands are recorded in voice of said owner to facilitate cooperation of said pet;
wherein said central processing unit comprises low voltage notification for said battery;
wherein said fastener comprises said pressure detecting lock and said alarm wire;
wherein said pressure detecting lock comprises an alarm wire for communicating and subsequently alerting when said fastener is disengaged;
wherein said transmitter continuously broadcasts a status of said pressure detecting lock;
wherein said charging port is useful for receiving a charging cable to charge a rechargeable said battery;
wherein said notifications are transmitted to a home computer/mobile device;
wherein said notifications are transmitted to multiple users in the event said pet distress notification is not addressed by said owner immediately; and
wherein said collar and said fastener, when fastened to said pet, permits said owner to track said pet utilizing said central processing unit contained within said inner volume of said collar as well as enabling said owner to train said pet by audible commands using said speaker.

18. The dog train & track system of claim 17 further comprising a kit including:
said collar for attaching to said neck of said pet;
said software disc for installing in said computer;
said rechargeable battery for powering said collar components;
said charge cable for charging said rechargeable battery; and
a set of user instructions.

19. A method of using a dog train & track system comprising the steps of:
attaching a collar around a neck of a pet;
programming software on a computer;
monitoring said pet utilizing said collar;
tracking said pet via said collar with GPS functionality;
removing said collar from said pet; and
charging said collar with a charge cable;

20. The method of claim 19 may further comprise the step of:
training said pet.
